(19) United States
(12) Patent Application Publication
(10) Pub. No.: US 2018/0306713 A1
(43) Pub. Date: Oct. 25, 2018

(54) ULTRA-SENSITIVE, REAL-TIME TRACE GAS DETECTION USING A HIGH-POWER, MULTI-MODE SEMICONDUCTOR LASER AND CAVITY RINGDOWN SPECTROSCOPY

(71) Applicant: Adelphi University, Garden City, NY (US)

(72) Inventors: Gottipaty Rao, West Hempstead, NY (US); Andreas Karpf, Floral Park, NY (US)

(21) Appl. No.: 15/960,315

(22) Filed: Apr. 23, 2018

Related U.S. Application Data
(60) Provisional application No. 62/489,718, filed on Apr. 25, 2017.

(51) Int. Cl. G01N 21/39; G01J 3/42

(52) U.S. Cl. CPC G01N 21/39; H01S 3/1062; G01J 3/42

(57) ABSTRACT

A highly sensitive trace gas sensor based on Cavity Ring-down Spectroscopy (CRDS) makes use of a high power, multi-mode Fabry-Perot (FP) semiconductor laser with a broad wavelength range to excite a large number of cavity modes and multiple molecular transitions, thereby reducing the detector's susceptibility to vibration and making it well suited for field deployment. The laser beam is aligned on-axis to the cavity, improving the signal-noise-ratio while maintaining its vibration insensitivity. The use of a FP semiconductor laser has the added advantages of being inexpensive, compact and insensitive to vibration. The technique is demonstrated using a laser with an output power of at least 200 mW, preferably over 1.0 Watt, (λ=400 nm) to measure low concentrations of Nitrogen Dioxide (NO₂) in zero air. For single-shot detection, 530 ppt sensitivity is demonstrated with a measurement time of 60 μs which allows for sensitive measurements with high temporal resolution.

### CROSS REFERENCE TO RELATED APPLICATION

The present application claims the benefit of U.S. patent application Ser. No. 62/489,718, filed Apr. 25, 2017, which is hereby incorporated by reference in its entirety.

### FIELD OF THE INVENTION

The present invention relates to highly sensitive trace gas sensors, and in particular trace gas sensors that utilize cavity ring-down detection techniques.

### BACKGROUND OF THE INVENTION

Monitoring of trace gases in a field environment (which is often prone to vibrations) in real-time is of interest in a wide range of fields, including defense and homeland security, environmental monitoring, and medical diagnostics. These applications require both high sensitivity (because the concentrations of the trace species are often at or below the parts-per-billion (10⁹) level), and high specificity of detection (since the target species will be in the presence of other gases, such as water vapor, nitrogen, oxygen, carbon dioxide, ammonia, etc.) Laser-based techniques are well suited for this task because they can achieve high sensitivity (especially when combined with long pathlength techniques) as well as high specificity (by targeting specific absorption lines of a desired species).

A variety of spectroscopic techniques have been developed for trace gas detection, each having its own merits and limitations. Commonly employed techniques include:
Absorption spectroscopy using long pass absorption cells such as multipass Herriott cells;
High-finesse optical cavity methods (e.g., Cavity Ringdown Spectroscopy, Cavity Enhanced Absorption Spectroscopy, etc.);
Photo-acoustic and quartz-enhanced photo-acoustic spectroscopy; and
Faraday rotation spectroscopy.

The current status of much of this work has been presented in peer reviewed articles by F. K. Tittel, Y. Bakhirkin, A. A. Kosterev and G. Wysocki, “Recent Advances in Trace Gas Detection Using Quantum and Interband Cascade Lasers,” Rev. of Laser Eng., vol. 34, pp. 275-282, 2006 (“Tittel”); R. F. Curl, F. Capasso, C. Gmachl, A. A. Kosterev, B. McManus, R. Lewicki, M. Pusharsky, G. Wysocki and F. K. Tittel, “Quantum cascade lasers in chemical physics,” Chem. Phys. Lett., vol. 487, pp. 1-18, 2010 (“Curl”); and G. N. Rao and A. Karpf, “External cavity tunable quantum cascade lasers and their applications to trace gas monitoring,” Appl. Opt., vol. 50, pp. A100-A115, 2011 (“Rao”), each of which is incorporated herein by reference in their entirety.

Techniques employing high-finesse optical cavities are of particular interest because they allow one to achieve very high degrees of sensitivity with a compact experimental cell. See J. J. Scherer and J. B. Paul, “CW Integrated Cavity Output Spectroscopy,” Chem. Phys. Lett., vol. 307, pp. 343-349, 1999 (“Scherer”); R. Engeln, G. Berden, R. Peeters and G. Meijer, “Cavity enhanced absorption and cavity enhanced magnetic rotation spectroscopy,” Rev. Sci. Instrum., vol. 69, p. 3763, 1998 (“Engeln”); J. B. Paul, L. Lapson and J. G. Anderson, “Ultrasensitive Absorption Spectroscopy with a High-Finesse Optical Cavity and Off-Axis Alignment,” Appl. Opt., vol. 40, pp. 4904-4910, 2001 (“Paul”); and G. Berden, R. Peeters and G. Meijer, “Cavity ring-down spectroscopy: Experimental schemes and applications,” Int. Reviews in Physical Chemistry, vol. 19, no. 4, p. 565-607, 2000. (“Berden”), each of which is incorporated herein by reference in their entirety. In particular, these techniques provide long pathlengths on the order of several km in a small effective volume.

A measurement technique of particular interest is Cavity Ring-Down Spectroscopy (CRDS) since it is capable of measuring trace concentrations of gases in an absolute scale, see Berden and A. O'Keefe and D. A. G. Deacon, “Cavity ring-down optical spectrometer for absorption measurements using pulsed laser sources,” Rev. Sci. Instrum., vol. 59, pp. 2544-2554, 1988 (“O'Keefe”) which is incorporated herein by reference in its entirety. In CRDS, a laser is coupled to a high-finesse optical cavity. The cavity has highly reflective mirrors at each end which cause light introduced into the cavity to reflect back and forth. Finesse is a measure of the cavity mirrors' reflectivity. In such a cavity, light is reflected back and forth thousands of times between the mirrors giving an effective pathlength on the order of kilometers. The laser is typically tuned such that it is in resonance with a cavity mode; as a result, light intensity builds up in the cavity due to constructive interference. When the light entering the cavity is interrupted (e.g., when a laser pulse ends), the intensity of the light inside the cavity decays exponentially since at each reflection a small fraction of light leaks out of the cavity.

The characteristic time of the decay is known as the cavity ringdown time and depends on the reflectivity of the cavity mirrors and their separation. For an empty cavity, the ring-down time (τ₀) is given by

$${τ}_{0} = \frac{l}{c ( 1 - R )} \qquad ( 1 )$$

where (1-R) denotes the reflection loss at the cavity mirrors, l is the distance between the mirrors of the cavity, and c is the speed of light. See, K. Busch, “Introduction to Cavity Ringdown Spectroscopy,” in Cavity Ringdown Spectroscopy, Washington, D.C., American Chemical Society, pp. 7-19, 1999 (“Busch”) and Englen, “An Introduction to Cavity Ringdown Spectroscopy,” in Cavity Ringdown Spectroscopy Techniques and Applications, Wiley, pp. 1-24, 2009 (“Lehmann”) which are incorporated herein by reference in their entirety. If an absorbing gas species is introduced into the cavity, an additional optical loss occurs resulting in a decrease in the cavity ring-down time. In the case of low concentrations of the absorbing species, the absorption follows Beer's law, and thus the decay of the light exiting the cavity will still be exponential and may be written as:

$$τ ( v ) = \frac{l}{c [ ( 1 - R ) + {\sum }_{i} {σ}_{i} ( v ) {\int }_{0}^{l} {N}_{i} ( x ) dx ]} , \qquad ( 2 )$$

where σᵢ(v) is the frequency dependent absorption cross section for each transition of each species, Nᵢ is the corresponding number density, and the sum is over all absorbing species present. See Berden, Busch and Lehmann. When the sample fills the cavity, the number density is integrated over the entire length of the cavity. When using a homogeneous mixture with only one species absorbing at the laser's frequency, one can replace the product Σᵢσ(v)∫Nᵢ(x)dx with an effective absorption coefficient α_{eff}(v) times l. The cavity ring-down time for homogeneous species filled in the cavity may then be written as:

$$τ = \frac{l}{c [ ( 1 - R ) + {α}_{eff} l ]} \qquad ( 3 )$$

If the gas' frequency dependent cross section is known, one can calculate the concentration from the cavity ring-down time:

$${α}_{eff} = σ N = \frac{1}{c} ( \frac{1}{τ} - \frac{1}{{τ}_{0}} ) \qquad ( 4 )$$

where τ is the ring-down time with the absorbing species present and τ₀ is the empty cavity ring-down time. See Berden, O'Keefe, Lehmann, and G. N. Rao and A. Karpf, “High sensitivity detection of NO₂ employing cavity ringdown spectroscopy and an external cavity continuously tunable quantum cascade laser,” App. Opt., vol. 49, pp. 4906-4914, 2010 (“Rao 2”) which is incorporated herein by reference in its entirety. The sensitivity of the detector, as described in the Berden article, is based on the precision of the measurement of the cavity ring-down time:

$${[ {α}_{eff} ]}_{min} = {σ [ N ]}_{min} = \frac{1}{c τ} \frac{Δτ}{τ} \qquad ( 5 )$$

Typically, with CRDS, an optical cavity and a narrow-linewidth, single mode laser are aligned on-axis, such that the TEM₀₀ mode is selectively excited. Therefore, the cavity's transmission is strongly dependent on matching the laser frequency to a cavity resonance. This occurs because light is only transmitted when the laser line overlaps a cavity resonance. Cavity resonances result from optical fields entering the cavity at different times and interfering together after different numbers of round trips. The transmitted intensity is described by K. K. Lehmann and D. Romanini, “The superposition principle and cavity ring-down spectroscopy,” J. Chem. Phys., vol. 23, pp. 10263-10277, 1996 (“Lehmann 2”) which is incorporated herein by reference in its entirety. According to Lehmann 2:

$${I}_{out} ( v ) = \frac{{T}^{2}}{{( 1 - R )}^{2} + 4 R {sin}^{2} ( \frac{2 π nVL}{c} )} {I}_{in} ( v ) , \qquad ( 6 )$$

where Iₒᵤₜ(v) is the transmitted spectral density, Iᵢₙ(v) is the input spectral density, T is the mirror transmissivity, R is the mirror reflectivity, c is the speed of light, n is the index of refraction within the cavity, and L is the cavity length. The interference results in transmission resonances at frequencies v_{q}=qc/2 nL (q is a positive integer). Thus, the cavity transmission can approach unity (for low loss mirrors 1−R≈T) when a narrow linewidth continuous wave (cw) laser excites a single longitudinal (TEM₀₀) mode in a cavity. This ideal case, however, can be technically challenging as it requires that the laser has a linewidth less than the cavity resonance width (typically ˜10's of kHz), be mode matched with the cavity, and be locked such that it does not drift away from the cavity resonance D. Romanini, L Ventrillard, G. Méjean, J. Morville and E. Kerstel, “Introduction to Cavity Enhanced Absorption Spectroscopy,” in Cavity-Enhanced Spectroscopy and Sensing, Berlin, Springer-Verlag, 2014, pp. 1-61 (“Romanini”) which is incorporated herein by reference in its entirety. It should be noted that the transmitted intensity at frequencies between the resonances drops to very low levels because the sine function is not near zero, and thus drops to as little as T²/4.

Small shifts in the cavity length (due to vibration) will result in a change to the cavity's resonant frequency, and thus can lead to large scale fluctuations in the transmitted signal (i.e., the laser line and cavity resonance will no longer overlap). This susceptibility to vibration can be removed using Off-Axis (OA) CRDS. See Paul, J. D. Ayers, R. L. Apodaca, W. R. Simpson and D. S. Baer, “Off-axis cavity ringdown spectroscopy: application to atmospheric nitrate radical detection,” Appl. Opt., vol. 44, pp. 7239-7242, 2005 (“Ayers”); G. N. Rao and A. Karpf, “Extremely sensitive detection of NO2 employing off-axis integrated cavity output spectroscopy coupled with multiple-line integrated absorption spectroscopy,” Appl. Opt., vol. 50, pp. 1915-1924, 2011 (“Rao 2”); and A. Karpf and G. N. Rao, “Detection of trace gases using frequency modulated off-axis cavity ring-down spectroscopy,” Proc. of SPIE 8358, pp. 83581D1-83581D9, 2012 (“Karpf”) which are incorporated herein by reference in their entirety. In this approach, off-axis alignment is used to excite a large number of cavity modes (approaching a continuum of modes). Specifically, this alignment spatially separates multiple reflections within the cell until at some point the ray (representing the path of the injected light) starts retracing its original path through the cavity (known as the re-entrant condition) See Paul. When a ray follows this path (up until the re-entrant condition being satisfied), there is no interference. If this path makes n round-trips through the cavity, then it is equivalent to a cavity that is 2n times longer, and results in an effective FSR that is n times smaller than the normal cavity FSR. Thus, off-axis alignment is used to create a condition where the effective FSR of the cavity is significantly narrower than the laser linewidth See Paul, Y. A. Bakhirkin, A. A. Kosterev, R. F. Curl, F. K. Tittel, D. A. Yarekha, L. Hvozdara, M. Giovannini and J. Faist, “Sub-ppbv nitric oxide concentration measurements using CW thermoelectrically cooled quantum cascade laser-based integrated cavity output spectroscopy Appl. Phys. B., vol. 82, pp. 149-154, 2006 (“Bakhirkin”); Y. A. Bakhirkin, A. A. Kosterev, C. Roller, R. F. Curl and F. K. Tittel, “Mid-infrared quantum cascade laser based off-axis integrated cavity output spectroscopy for biogenic nitric oxide detection,” Appl. Opt., vol. 43, pp. 2257-2266, 2004 (“Bakhirkin 2”) which are incorporated herein by reference in their entirety. As a result, the laser will always be resonant with some set of cavity modes (regardless of slight changes to the cavity length due to vibrations or small drifts in the laser frequency). A key design issue, however is that the cavity mirrors need to be large enough to allow multiple reflections within the cavity without causing beam overlap on the mirrors. If overlapping occurs, there will be a decrease in the signal-to-noise ratio See Bakhirkin 2. This requirement for using large mirrors (diameter˜50 mm) causes a complication. Specifically, many applications require the use of a low-volume cell. In order to maintain a small volume while using larger mirrors, one must reduce the spacing between the mirrors, resulting in reduced sensitivity due to the shorter pathlength.

Another drawback to off-axis alignment is that the low coupling efficiency of the laser to the cavity results in a weak transmitted signal. In the case of off-axis alignment one intentionally excites as many cavity modes as possible (i.e., many transverse cavity modes). However, the average cavity transmission is significantly reduced from that of the ideal case, and is given by:

$${I}_{out} = \frac{{I}_{in} {C}_{P} T}{2 ( 1 - R )} \qquad ( 7 )$$

where C_{P} is the cavity coupling parameter (a measure of the spatial mode quality of the beam and the degree of mode matching between the laser and the cavity). See J. B. Paul, L. Lapson and J. G. Anderson, “Ultrasensitive absorption spectroscopy with a high-finesse optical cavity and off-axis alignment,” Appl. Opt., vol. 40, pp. 4904-4910, 2001 (“Paul 2”) which is incorporated herein by reference in its entirety. It should be noted that Eq. (7) pertains to light transmitted through the rear mirror, and that the factor of ½ comes from the fact that light exits through both front and back cavity mirrors. The cavity coupling parameter will have a value between 0 and 1: C_{P} will approach 1 for a TEM₀₀ cw laser with a high degree of mode matching with the cavity; it will be significantly lower (C_{P}˜0.1) for a pulsed laser See Paul 2. Thus, exciting a large number of modes allows one to record spectra without gaps caused by the transmission spectrum of the cavity, as well as limit the effects of vibration, but the transmitted intensity will be reduced by more than a factor of the mirror transmissivity T from the ideal case. For typical cavity mirrors (R˜0.9998 and T˜0.00005), the cavity transmission may be reduced from the ideal case by a factor of 10⁶ or greater.

### SUMMARY OF THE INVENTION

The present invention is a high-precision, vibration-insensitive trace gas detection apparatus and method based on cavity ringdown spectroscopy (CRDS) using a high power, broad-band laser source, e.g., a multi-mode Fabry-Perot (“FP”) semiconductor laser with a power output of about 200 mW or more. The present invention is capable of making sensitive measurements in timescales of tens of microseconds without the problems of vibration susceptibility and low-throughput. It also employs as simple structure.

Typical prior art implementations of CRDS make use of a narrow-linewidth laser source. This can provide a large signal-to-noise ratio, but also makes the apparatus very susceptible to vibrations. As a result, such implementations of CRDS are difficult to implement for field use unless additional steps are taken to remove vibrations from the apparatus.

The present invention uses a high-power, multi-mode, broad-band Fabry-Perot (FP) semiconductor laser source with CRDS to address the problems of the susceptibility of CRDS to vibration and low throughput, while still providing the sensitivity typically achieved using narrow-linewidth lasers and a simple design. Broad-band FP laser sources of this type emit dozens of modes, typically in a Gaussian-like envelope with a width on the order of 1 nm. This frequency spread is narrow enough that individual target species can be selectively monitored, but still broad enough that it will excite a large number of cavity modes and remove the need for tuning of the laser source.

In the case of such a relatively broad laser source, its emission will cover on the order of a thousand FSR (assuming a typical cavity with FSR˜300 MHz), and thus will excite a large number of cavity modes. FSR is “free spectral range” and is defined in terms of the frequency separation between two successive transmission frequencies (or resonance modes) of the optical cavity at normal incidence. As a result, any slight change to the cavity length due to vibrations will simply shift this array of cavity resonances to other wavelengths in which the laser is emitting (i.e., the laser will always be resonant with the cavity) and thus removes the susceptibility to vibrations. This is essentially the same condition as off-axis CRDS (OA-CRDS). Specifically, in the case of off-axis alignment, an effective FSR is created that is significantly less than the laser bandwidth. As a result, the energy coupled to the cavity is no longer a function of wavelength. See Romanini. On the other hand, when using a broad-band laser with on-axis alignment, this condition is achieved by having a laser whose bandwidth is much greater than the natural (i.e., on-axis) FSR of the cavity.

The cavity throughput using on axis CRDS is still described by Eq. 7, and thus leads to a similar reduction in transmitted light intensity as with off-axis alignment. The low output light power requires longer integration times, expensive high-power detectors and can limit the use of the device for real-time measurement. Such a setup is described in H. Fuchs, W. P. Dube, B. M. Lerner, N. L. Wagner, E. J. Williams and S. S. Brown, “A sensitive and versatile detector for atmospheric NO2 and NOx based on blue diode laser cavity ring-down spectroscopy,” Environ. Sci. Technol., vol. 43, pp. 7831-7836, 2009 (“Fuchs”), which is incorporated herein by reference in its entirety. The present invention resolves this problem in a novel way by using a relatively inexpensive, high-power (e.g., above 200 mW) FP semiconductor laser. These lasers are typically designed for industrial applications, and emit at powers that are one to two orders of magnitude times greater than lasers typically employed for CRDS. More importantly, high-powered lasers have not previously been used in trace gas detection applications. For example, an embodiment of the present invention was tested with a FP laser with a 1.1W output, which is 25 times greater than that used by Fuchs, et al. Not only did this result in a correspondingly large increase in the signal-to-noise ratio, it enabled the use of less expensive, durable, low-power, solid-state detectors. Equally important, the test showed that the invention has the ability to make measurements at the sub-ppb level on time scales on the order of tens of μs (significantly shorter than any previous Cavity Ringdown measurements). Short time scales of this order of magnitude enable measurements that open the door for real time monitoring of trace toxic species, as well as investigation of chemical reactions that take place (e.g., the reactions nitrogen oxides undergo in the atmosphere to form smog).

The advantage to the approach according to the present invention is four-fold. First, a simple Fabry-Perot semiconductor laser can be used as opposed to more expensive and complex narrow-linewidth laser systems such as external cavity (“EC”) or distributed feedback semiconductor (“DFB”) lasers. For example, high power FP diode lasers cost $200 or less depending on the desired specifications. Fabry-Perot semiconductor lasers, unlike EC semiconductor lasers, are very compact and are not sensitive to vibrations. Second, since the excitation of a large number of cavity modes is not due to the use of off-axis geometry, there is no need to use large diameter mirrors. Smaller diameter mirrors result in cavities with smaller volumes; this allows for quicker sample acquisition. Third, there is no restriction to the cavity alignment necessary to prevent the overlapping of reflected beams (i.e., the cavity's natural FSR (c/nL) because a single round-trip through the cell determines the sensor performance as opposed to an effective FSR resulting from off-axis geometry. Thus, simplified alignment and improved signal-to-noise ratio are achieved. Fourth, the use of a high-power semiconductor laser results in a further improvement to the signal-to-noise ratio and allows the use of a low power detector, such as an avalanche photodiode, as opposed to high-voltage photomultiplier tubes or photon counters. Additionally, the use of a high-power laser allows for highly-sensitive measurements on time scales on the order of tens of microseconds, a capability not yet demonstrated by commercial implementations of CRDS, and thus opening the door to interesting, real-time investigation of trace gas concentrations.

The excitation of multiple cavity modes has the potential to complicate the determination of the decay constant. Specifically, there can be a modulation in the exponential decay known as mode-beating as well as multi-exponential components to the decay See Lehmann 2, J. J. Scherer, J. B. Paul, A. O'Keefe and R. J. Saykally, “Cavity ringdown laser absorption spectroscopy: History, development, and application to pulsed molecular beams,” Chem. Rev., vol. 97, pp. 25-51, 1997 (“Scherer 2”); P. Zalicki and R. N. Zare, “Cavity ring-down spectroscopy for quantitative absorption measurements,” J. Chem. Phys., vol. 102, pp. 2708-2717, 1995 (“Zalicki”) which are incorporated herein by reference in their entirety. If multiple longitudinal modes are excited, beats between the modes may cause a modulation in the decay waveform. See Zalicki. This beat pattern is specific to the longitudinal mode structure that builds up from each pulse; as a result, the mode structure may vary from pulse to pulse due to shifts in the relative phase of the modes. The beat pattern washes out significantly if one averages multiple pulses. See Zalicki. The excitation of multiple transverse modes may lead to transverse mode beating. In this case, however, the effects from the beating may be removed by collecting the entire cross-section of the beam exiting the cavity and focusing it onto the detector (e.g., via the use of a lens or off-axis parabolic reflector). See Lehmann 2. A multi-exponential decay can result if the cavity mirror reflectivity pertaining to each mode (defined as the mode dependent reflectivity Rₘₙ (v)) varies from mode to mode. The value for each Rₘₙ(v) can vary for modes with different transverse profiles if distinct portions of the mirrors have different reflectivities due to dirt or dust, or if the reflectivity of the mirror coating varies significantly as a function of frequency. See Scherer 2 and Lehmann 2. If, however, the reflectivity is constant, or has only small deviations from an average value, monoexponential decay will result, corresponding to the effective reflectivity. In the case of an embodiment of the present invention tested, the mirror reflectivity was effectively constant over the 0.6 nm wavelength range covered by the laser.

In order to apply Beer's law to determine the concentration of an absorbing species in the cell, the range of frequencies covered by the excited cavity modes must be much narrower than the width of the absorption feature, such that the coefficient α(v) describing the absorption may be treated as a constant over the frequency range. If α(v) has only small deviations from an average value, a monoexponential decay will result corresponding to the effective absorption coefficient. In such a case, to obtain an accurate concentration measurement, the effective absorption coefficient can be calculated by taking a weighted average of the absorption cross-section across the laser profile.

### BRIEF DESCRIPTION OF THE DRAWINGS

The foregoing and other features of the present invention will be more readily apparent from the following detailed description and drawings of an illustrative embodiment of the invention in which:

FIG. 1 is a schematic diagram of an exemplary embodiment of apparatus for carrying out the demonstration of the present invention;

FIG. 2 shows the emission spectrum of the multi-mode Ushio model HL40033G diode laser and the NO₂ absorption spectrum;

FIG. 3 illustrates Cavity Ringdown decays recorded for Zero Air and two different concentrations of NO₂;

FIG. 4 shows a plot of [(1/τ)−(1/τ₀)] vs. measured concentration of NO₂ in Zero Air;

FIG. 5A shows the Cavity ringdown times recorded with Zero Air flowing through the cell at 0.5 liter/min with a single shot, FIG. 5B shows ringdown times with 32 decays averaged and FIG. 5C shows ringdown times with 512 decays averaged; and

FIG. 6 is a log-log plot of standard deviation of CRDS signal vs Number of averages.

### DETAILED DESCRIPTION OF AN EXEMPLARY EMBODIMENT OF THE INVENTION

A new trace gas detection technique and its applications are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below. More specifically, some of the details provided below include the demonstration of the invention to detect NO₂. The details specific to NO₂ detection (for example the use of a multi-mode diode laser emitting near 405 nm), pertain to the embodiment described and are not intended to limit the invention to this specific laser, wavelength, molecular species or any other particulars of the embodiment. The invention may be implemented to detect other molecular species using a FP semiconductor laser emitting at the appropriate wavelength (e.g., FP diode lasers or FP quantum cascade lasers provide access to large regions in the visible, near-infrared and mid-infrared, allowing one to detect a large number of different trace gases). Instead, the invention is intended to be limited only by the appended claims.

According to the present invention, trace concentrations of a gas, e.g., NO₂, are measured by cavity ringdown spectroscopy (CRDS) using a high power Fabry-Perot (FP) diode laser, i.e., 200 mW and above. There were two main factors that needed to be considered for the selection of a wavelength region for this work: 1) Select a region with strong absorption lines; and 2) Select a region that is free from interference due to other species (especially water vapor). Some of the strongest NO₂ rovibronic transitions are in the region accessible using 405 nm diode lasers See Voigt. A review of the spectra of the main atmospheric components L. S. Rothman, et. al, “The HITRAN 2008 molecular spectroscopic database,” J. Quant. Spectrosc. Radiat. Transfer, vol. 110, pp. 533-572, 2009 (“Rothman”); C. N. Mikhailenko, Y. L. Babikov and V. F. Golovko, “Information-calculating system Spectroscopy of Atmospheric Gases. The structure and main functions,” Atmos. Oceanic Opt., vol. 18, pp. 685-695, 2005 (“Mikhailenko”); NASA, “Atmosphere, Earth Fact Sheet—Terrestrial,” [Online at: http://nssdc.gsfc.nasa.gov/planetary/factsheetearthfact.html (“NASA”) which are incorporated herein by reference in their entirety, show that there are no interfering species (including water vapor) within several nm on either side of the laser line (λ˜405 nm). Thus despite the relatively broad linewidth of the laser (Δλₗₐₛₑᵣ˜0.6 nm), with some care in choosing an appropriate spectral window a high sensitivity sensor for the molecular species can be realized with minimal interferences from other trace species and water vapor.

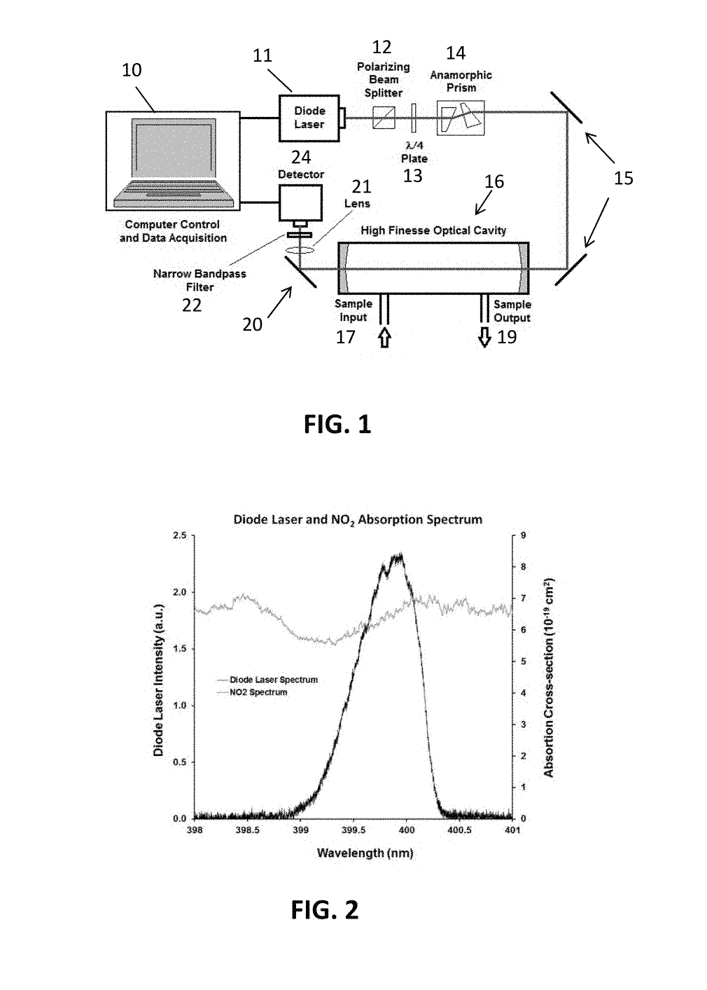

FIG. 1 shows an embodiment of apparatus configured for demonstrating CRDS using a high power, multi-mode diode laser as a means for measuring trace concentrations of NO₂. The apparatus includes a diode laser 11 whose operation is directed by a computer control and data acquisition system 10. The beam from laser 11 passes through optics, which include a polarizing beam splitter 12 and a quarter wave plate 13 that provide optical isolation from the back reflection of the optical cavity. Useful in practicing the present invention is an Ushio model HL40033G multi-mode diode laser. Its light output is on the order of 1 W, its wavelength range is 0.6 nm and it has approximately 50 modes (each mode's width is much larger than the cavity's FSR).

The optical system also includes an anamorphic prism 14 that is used to shape the asymmetric diode laser beam. The beam from the prism 14 is directed by mirrors 15 so it enters a High Finesse Optical Cavity 16 on axis. In the cavity it encounters the sample gas which flows through the cavity from an input 17 to an output 19. The output of the cavity is reflected by a mirror 20 through focusing optics (lens 21, filter 22) to a detector 24. Detector 24 converts the optical signal into an electrical signal that is input to the data acquisition portion of computer 10.

Using the apparatus of FIG. 1 CRDS was conducted on several NO₂ concentrations (20, 40, 60, and 80 ppb) fed through the cell at 0.5 liter/min. The Cavity Ring-Down Cell was constructed using components and mirrors purchased from CRD-Optics, Inc. The Cavity Ring-Down cell is 50 cm long. The mirrors have a radius of curvature of 6 meters, and a reflectivity of 99.97% at 400 nm.

The diode laser 11 of FIG. 1 was operated in pulsed mode at a frequency of 4 kHz using a Newport LDP-3840B pulse driver. The duty cycle was 10%, resulting in a pulse duration of 25 μs. The laser pulse width was chosen such that about four cavity ring-down times are covered. The laser pulse rise and fall times are approximately 50 ns. The diode laser's modes were contained in a Gaussian-like envelope centered at 399.8 nm with a FWHM of approximately 0.6 nm. The close spacing of the energy levels in NO₂, and the large width of the absorption features at 1 atmosphere resulted in very broad absorption features. See the Karpf 2 article. As a result, the absorption features did not vary significantly over the wavelength range of the laser. The effective absorption coefficient was calculated to be σ_{eff}˜6.4×10⁻¹⁹ cm² by taking a weighted average of the absorption cross-section across the laser profile.

FIG. 2 displays the multi-mode diode laser spectrum as well as the absorption spectrum of NO₂ in the region of interest. The injection current for the laser was 900 mA, the temperature was 25° C., and the spectrum was recorded using a SPEX 1000M monochromator. It should be noted that this spectrum was recorded over several seconds and thus was comprised of many thousands of laser pulses. Small deviations in the mode structure in each pulse washed out the mode structure seen in the figure, resulting in the relatively “smooth” spectrum seen in FIG. 2. Previous spectra were recorded using a similar model Ushio laser in cw-mode and that spectra exhibited a well-defined mode structure. See, A. Karpf and G. N. Rao, “Real-time trace gas sensor using a multimode diode laser and multiple-line integrated cavity enhanced absorption spectroscopy,” Appl. Opt., vol. 54, pp. 6085-6092, 2015 (“Karpf 2”), which is incorporated herein by reference in its entirety. The NO₂ absorption spectrum shown in FIG. 2 is for room temperature (298.5 K) and at atmospheric pressure over the laser's wavelength range. See, S. Voigt, J. Orphal and J. P. Burrows, “The temperature and pressure dependence of the absorption cross-sections of NO₂ in the 250-800 nm region measured by Fourier-transform spectroscopy,” J. Photochem. Photobiol. A: Chem., vol. 149, pp. 1-7, 2002 (“Voigt”) which is incorporated herein by reference in its entirety. At atmospheric pressure, the dense ro-vibronic spectrum of NO₂ results in very broad, overlapping absorption features.

In FIG. 1, light exiting the cavity 16 was focused on the detector 24 using a large diameter, short focal length lens 21. The ring-down decays were detected using an avalanche photodiode (Advanced Photonix model SD 197-70-74-661) as the detector. Its output was fed to a Tektronix DP03034 digitizing oscilloscope with a 300 MHz bandwidth and 2.5 GS/s sample rate used as part of the computer control and data acquisition system 10. Averaging of multiple decays was accomplished using the oscilloscope's onboard processing circuits. The oscilloscope output was fed to a personal computer (PC), which was also part of system 10 via USB connection. Additional averaging (when necessary) as well as curve fitting were done using a virtual instrument programmed using the LabView program.

The high finesse optical cell or cavity 16 had input and output valves 17, 19 allowing test gas mixtures to flow through the cavity at a constant rate. Mixtures of 20, 40, 60 and 80 ppb of NO₂ were passed through the cell at 0.5 liter/min for the test of the embodiment. The gas mixtures were prepared by diluting a pre-calibrated 1 ppm mixture of NO₂ in Zero Air (a mix of 20.9% 02 and 79.1% N₂) with additional Zero Air.

A brief demonstration of the apparatus' reduced sensitivity to vibration was tested by mounting an unbalanced electrical motor to the breadboard immediately next to the cell. The motor rotated an off-center wheel that introduced relatively low frequency (<100 Hz) vibrations into the apparatus. The vibrations could easily be felt when touching the cell. The susceptibility of the apparatus to small shocks and higher frequency vibrations was tested by repeatedly, sharply striking the breadboard with a wrench (with mild force). The quick strikes likely also contained higher frequency vibration components. Although the detailed profile of the vibrations introduced to the system was not measured, the test demonstrated the basic reduced susceptibility to vibration of the system.

The 400 nm laser beam incident on the optical cavity caused the fused silica substrate of the cavity mirrors, as well as the collimating lens and other optical elements, to fluoresce in the 450 nm to 550 nm range. The transmission of the cavity mirror coatings at these wavelengths was orders of magnitude higher than the transmission at 400 nm. As a result, the intensity of the fluorescence incident on the sensor was significantly higher than the low power levels of 400 nm light exiting the cavity (˜2 μW), and thus distorted the desired signal. To block this interference, a narrow band-pass filter 23, with a 40 nm bandwidth centered at 400 nm, was placed before the detector 24. This use of a narrow band-pass filter is important to successfully use a high-power semiconductor laser to detect NO₂ using multi-mode CRDS.

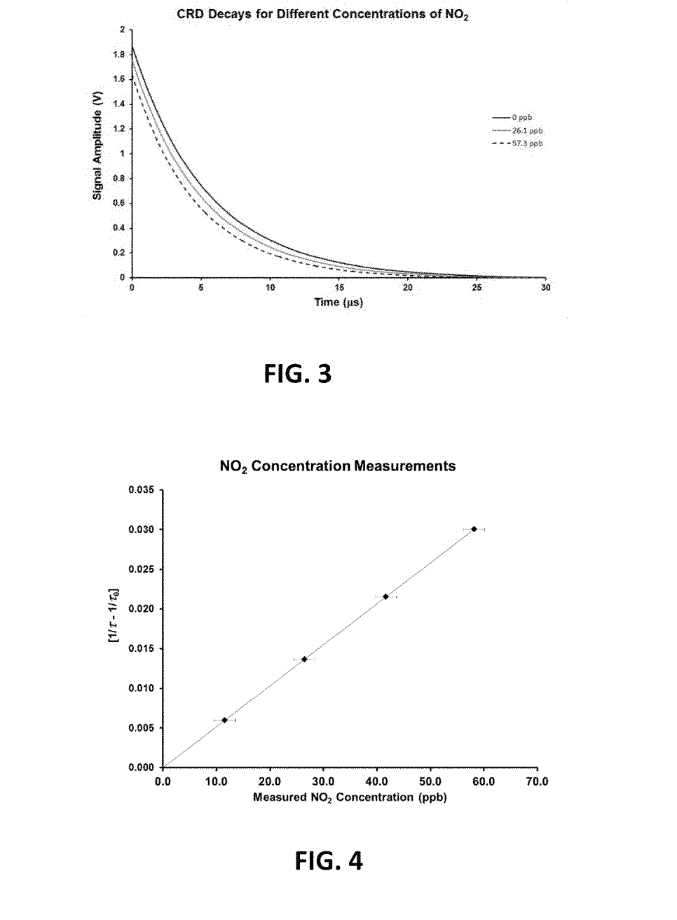

In FIG. 3 the Cavity Ringdown decays are recorded for Zero Air and two different concentrations of NO₂. Samples were passed through the cell at 0.5 liter/min and 512 decays were averaged for each data set. Cavity ringdown times were calculated by using an iterative general Least Square method and the Levenberg-Marquardt method to fit 40 is of data from each decay to an exponential curve of the form (Ae^{-bx}+c). It should be noted that the initial 100 ns from each decay was omitted from the fit in order to avoid distortion to the fit due to light still entering the cavity as the incident laser pulse ended.

Concentrations of the test gases were calculated using Eq. 4. A plot of ((1/τ)−(1/τ₀)) vs. measured NO₂ concentration shows the expected linear relationship. See FIG. 4. In FIG. 4 the horizontal error bars represent the uncertainty in preparing the gas mixtures (i.e., mixtures could only be generated with a precision of ±3 ppb). It should be noted that the measured values of the NO₂ concentration were found to be approximately 60% of that specified by the mixture. This difference is not unexpected since the pre-calibrated 1 ppm cylinder of NO₂ was over 2 years old, which is over a year beyond its expiration date (the age of the cylinder lowers its expected concentration). It should be noted that the measured NO₂ concentrations are in agreement with previous measurements using Cavity Enhanced Absorption Spectroscopy and a variation of this apparatus, see Karpf 2.

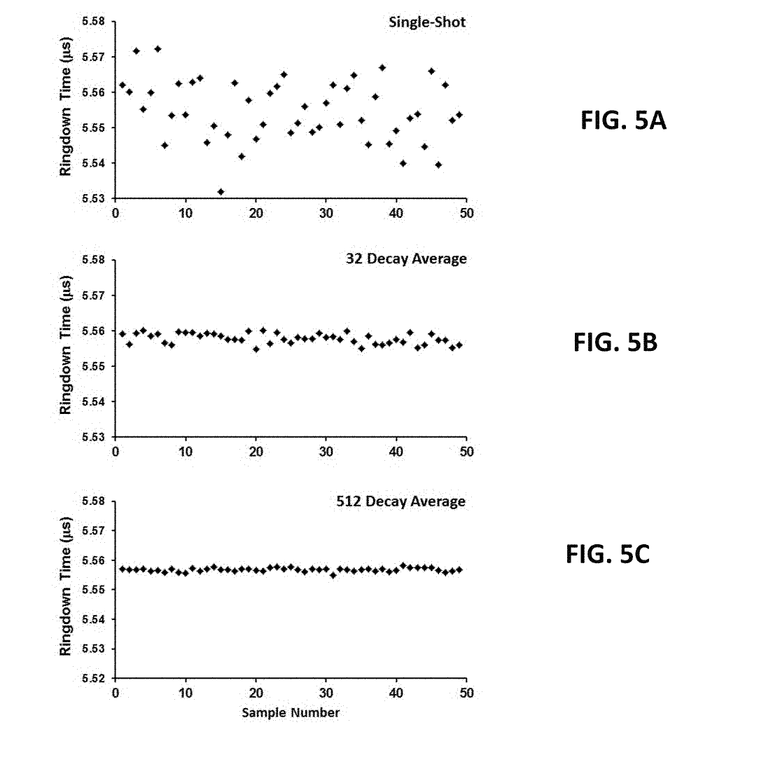

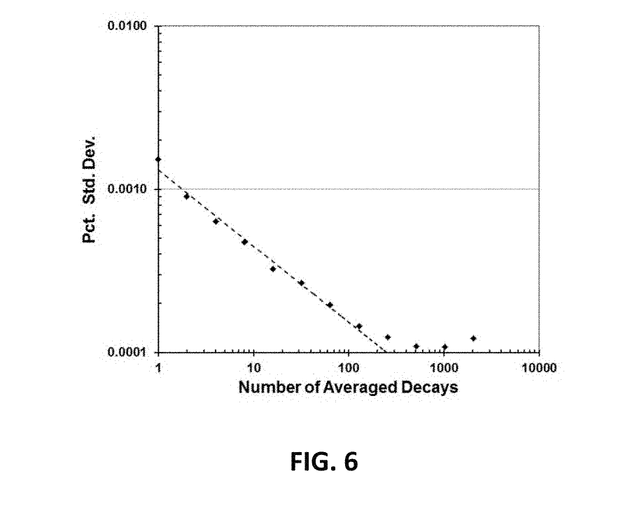

In order to determine the sensitivity of the detector system, the signal was recorded by averaging different numbers of decays (2048, 1024, 512, 256, 128, 64, 32, 16, 8, 4, 2 and 1), with 0.5 liter/min of zero air flowing through the cell. Fifty data sets were recorded for each specified number of averages, and the standard deviation was calculated. FIG. 5 shows the reduction in the fluctuations in the measured CRD time obtained by averaging multiple decays. Specifically, these figures illustrate the magnitude of fluctuations (and thus the standard deviation) in the CRD times with different numbers of decays averaged. FIG. 5A shows the most fluctuations for the single shot case. FIG. 5B is for the average of 32 decays, and FIG. 5C is for the average of 512 decays. The reduced fluctuations with increased average decays result in a smaller uncertainty in determining the CRD time (i.e., Δτ), and thus via Eq. (4) results in improved sensitivity. A log-log plot of the standard deviation vs. number of averages shows that the optimal sensitivity occurs with the averaging of 512 decays (see FIG. 6).

The sensitivity of the apparatus was found by rewriting Eq. (4), such that:

$${[ N ]}_{min} = \frac{1}{c {σ}_{eff} τ} \frac{Δτ}{τ} . \qquad ( 8 )$$

where [N]ₘᵢₙ is the sensitivity in ppb, τ is the cavity ringdown time with a 0.5 liter/min zero air flow, Δτ is the standard deviation in the measurement of τ, and σ_{eff} is the effective absorption cross-section equal to 6.4×10⁻¹⁹ cm². With averaging of 512 decays, Δτ/τ was measured to be 0.01%, corresponding to a sensitivity of 38 ppt of NO₂ in Zero Air with an integration time of 128 ms. Using single shot detection (i.e., no averaging), Δτ/τ was measured to be 0.15%, corresponding to a sensitivity of 530 ppt of NO₂ in Zero Air with a measurement time of only 60 μs.

A more general view of this sensitivity may be seen in terms of the device's Noise Equivalent Absorption Coefficient of 1.5×10⁻⁹ cm⁻¹ Hz^{-1/2}. The dashed line in the Allen plot in FIG. 6, shows the percent standard deviation (Δτ/τ) expected for random noise. The fact that the standard deviation obtained for larger numbers of averages leaves this dashed line results from signal fluctuations that are not due to white noise but possibly from the slower, temperature-based fluctuations in the avalanche photodiode output. The same test was conducted with vibrations introduced into the apparatus (using the electric motor described above). With averaging 512 decays, Δτ/τ was measured to be 0.01%, indicating that vibrations had no significant effect on the sensitivity of detection. In addition, a qualitative test was conducted where the base of the apparatus was repeatedly struck with a wrench (also described above), and no change was observed in the CRD signal on the oscilloscope.

It is important to note, however, that the sensitivity of the embodiment of the invention described herein is limited in part due to a temporary lack of commercially available CRD mirrors whose coatings were matched to the 400 nm laser used. Specifically, several pairs of mirrors were tested with coatings specified to have maximum reflectivity in the 405 to 415 nm range. The best results were obtained using a pair of mirrors from CRD Optics whose specifications indicated that they had a reflectivity of 99.995% at 410 nm. It is expected that if mirrors with acceptable coatings at 400 nm were available, or similarly if high power HL40033G lasers were available in a wavelength near 410 nm, that even better results would be obtained. Using light that was 10 nm away from the optimal mirror wavelength resulted in reduced reflectivity. These mirrors had a reflectivity at 400 nm of 99.97%. As a result, the pathlength used to obtain the present results was only ˜1700 m (i.e., a factor of 10 shorter than what would be achieved using 99.995% reflective mirrors). It would therefore be reasonable to expect a significant (factor of 10+) improvement to the sensitivity is achievable using the invention with a better match between the laser and mirrors.

Despite the limitation described above, the reported results with the present invention compare favorably with other CRDS measurements of NO₂ concentrations. For example: A sensitivity of 80 ppt of NO₂ with a sample time of 50 seconds was reported using an external cavity diode laser system. R. Wada and A. J. Orr-Ewing, “Continuous wave cavity ring-down spectroscopy measurement of NO₂ mixing ratios in ambient air,” Analyst, vol. 130, pp. 1595-1600, 2005 (“Wada”) which is incorporated herein by reference in its entirety. A 40 ppt sensitivity with a measurement time of 1 second was achieved using a pulsed Nd:YAG laser at 532 nm. H. D. Osthoff, S. S. Brown, T. B. Ryerson, T. J. Fortin, B. M. Lerner, E. J. Williams, A. Pettersson, T. Baynard, W. P. Dube, S. J. Ciciora and A. R. Ravishankara, “Measurement of atmospheric NO₂ by pulsed cavity ring-down spectroscopy,” Jrnl. Geophys. Research, vol. 111, pp. D12305 1-10, 2006 (“Osthoff”) which is incorporated herein by reference in its entirety. A sensitivity of 60 ppt with an integration time of 60 seconds was reported using a modified commercial, diode-laser based CRD detector. P. Castellanos, W. T. Luke, P. Kelley, J. W. Stehr, S. H. Ehrman and R. R. Dickerson, “Modification of a commercial cavity ring-down spectroscopy NO2 detector for enhanced sensitivity,” Rev. Sci. Inst., vol. 80, pp. 113107-1-113107-6, 2009 (“Castellanos”) which is incorporated herein by reference in its entirety. Further, a sensitivity of 80 ppt with an integration time of 60 s was achieved using a light emitting diode based commercial CRD detector. L. C. Brent, et. al., “Evaluation of the use of a commercially available cavity ringdown absorption spectrometer for measuring NO₂ in flight, and observations over the Mid-Atlantic States, during DISCOVER-AQ,” Jrnl. Atm. Chem., vol. 72, pp. 1-19, 2013 (“Brent”).

Fuchs, et. al., used a low power (˜40 mW), FP diode laser (λ˜404 nm) to conduct CRDS and achieved a sensitivity of 22 ppt of NO₂, which is comparable to that of the present invention, but with a measurement time of 1 second, which is approximately an order of magnitude longer than the present invention. It is worth noting, however, that this result was achieved using mirrors that were well matched to their laser (i.e., R=99.9965%) and a cell that was nearly twice the length of that in the present invention. As a result, the pathlength used to achieve the result reported by Fuchs was over 16 times greater (˜27 km) than that of the present invention. This suggests that in addition to the temporal improvement achieved using the present invention reported approach, the use of a high-power FP laser should result in an order of magnitude improvement in sensitivity when conducted with mirrors that are well matched to the laser source. This improvement would be expected considering the factor of 25 difference in power between the laser sources used by Fuchs, et. al., and that used by the present invention.

While the invention has been particularly shown and described with reference to preferred embodiments thereof, it will be understood by those skilled in the art that various changes in form and details may be made therein without departing from the spirit and scope of the invention.

We claim:

1. A method for detecting trace gases in a gas sample using cavity ringdown spectroscopy, comprising the steps of:
generating a laser beam with a high power, multimode Fabry-Perot semiconductor laser;
passing said laser beam on axis into a high finesse optical cavity cell in which the sample gas is located;
terminating the beam;
detecting the decay of the light exiting the cavity upon termination of the laser beam; and
using the time constant of the decay to determine a concentration of a target molecular species in the gas sample.

2. The method of claim 1 wherein the wavelength range of the diode laser is about 0.6 nm.

3. The method of claim 1 wherein the power of the diode laser is greater than about 200 mW.

4. The method of claim 1 wherein the broadband multi-mode laser beam excites a large number of cavity modes and molecular transitions, thereby making the apparatus insensitive to vibration.

5. The method of claim 4 wherein the molecular species is NO2, the high power FP semiconductor laser power is greater than 1 W, the wavelength of the laser is about 400 nm and about 512 decays are averaged.

6. Apparatus for detecting trace gas species in a gas sample using cavity ringdown spectroscopy, comprising:
a high power, multimode Fabry-Perot semiconductor laser system with a broad wavelength range generates at least one laser beam pulse;
a high finesse optical cavity cell in which the sample gas is located;
a reflector for directing the laser beam on axis into the cavity cell;
a photodetector for detecting the decay of the light pulse exiting the cavity upon termination of each pulse; and
a processor for using the time constant of the decay to determine a concentration of a target molecular species in the gas sample.

7. The apparatus of claim 4 wherein the cell has an entrance through which the sample gas enters the cell at one end, and an exit from which the sample gas exits at the other end.

8. The apparatus of claim 4 wherein a narrow bandpass filter is used to block fluorescence originating from the interaction of the high-power laser light and the glass substrates of the optical elements (e.g., the cavity ringdown mirrors), from interfering with the transmitted signal from the high finesse optical cavity, as necessary.
